(19) United States
(12) Patent Application Publication
(10) Pub. No.: US 2017/0241162 A1
(43) Pub. Date: Aug. 24, 2017

(54) Pick Proof Lock

(71) Applicant: Scott A. Densmore, Sedalia, CO (US)

(72) Inventor: Scott A. Densmore, Sedalia, CO (US)

(21) Appl. No.: 14/513,546

(22) Filed: Oct. 14, 2014

Related U.S. Application Data
(60) Provisional application No. 62/031,270, filed on Jul. 31, 2014.

(51) Int. Cl. E05B 17/20; E05B 13/00

(52) U.S. Cl. CPC E05B 17/2084; E05B 13/002

(57) ABSTRACT

A tamper proof lock has a bolt with a retracted position and an extended position. A knob has a first position wherein a key operates the bolt and a second position wherein the key does not operate the bolt. A key plate is in opposition to the knob having a key slot. The knob has a locking collar attached to the shaft of the thumb knob. The locking collar has a locking orifice. A thumb knob plate has a locking pin that engages the locking orifice in the second position, wherein the thumb knob is pulled out from the thumb plate. This also stops a key inserted into the key plate from operating the bolt. As a result, bumping, picking, drilling the lock, or using an unauthorized key will be ineffective to open a door with this invention in the second position.

### RELATED APPLICATIONS

The present invention claims priority on provisional patent application, Ser. No. 62/031,270, filed on Ju. 31, 2014, entitled “Deadbolt Locking Device: Manual Safety” and on provisional patent application, Ser. No. 62/898,266, filed on Oct. 31, 2013, entitled “Door Deadbolt Reinforcement Device” and are hereby incorporated by reference

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Locks are how we secure our valuables, our houses, and protect our families. Unfortunately, standard key locks can be picked, drilled, or bumped. Electronic locks and home automation capabilities add in the vulnerability of unauthorized electronic access or hacking. These leave homeowners vulnerable. In addition, if a homeowner loses a key or a copy is made or kept without their knowledge someone can gain access to the homeowner's house

Thus there exists a need for a lock that cannot be picked, bumped, drilled, or electronically hacked and which protects against lost or unauthorized keys.

### BRIEF SUMMARY OF INVENTION

A tamper proof lock that overcomes these and other problems has a bolt with a retracted position and an extended position. A knob has a first position wherein a key operates the bolt and a second position wherein the key does not operate the bolt. A key plate is in opposition to the knob having a key slot.

In one embodiment, the knob has a locking collar attached to the shaft of the thumb knob. The locking collar has a locking orifice. A thumb knob plate has a locking pin that engages the locking orifice in the second position, wherein the thumb knob is pulled out from the thumb plate. This also stops a key inserted into the key plate from operating the bolt. As a result, bumping, picking, or drilling the lock will be ineffective to open a door with this invention in the second position as will be unauthorized keys.

As will be clear to those skilled in the art there are numerous ways in which the bolt may be locked (or disengage) in place and therefore make the deadbolt lock tamper proof. All such mechanisms are incorporated as part of the invention.

### BRIEF DESCRIPTION OF THE SEVERAL VIEWS OF THE DRAWINGS

FIG. 1 is an exploded view of a deadbolt lock;

FIG. 2 is a side view of a thumb knob for a deadbolt lock in accordance with one embodiment of the invention;

FIG. 3 is an end view of the thumb knob of FIG. 2 in accordance with one embodiment of the invention;

FIG. 4 is a side view of a locking collar for a deadbolt lock in accordance with one embodiment of the invention;

FIG. 5 is a front view of the locking collar of FIG. 4 in accordance with one embodiment of the invention;

FIG. 6 is a back view of a thumb knob plate for a deadbolt lock in accordance with one embodiment of the invention;

FIG. 7 is a side view of the thumb knob plate of FIG. 6 in accordance with one embodiment of the invention;

FIG. 8 is a side view of the thumb knob, thumb plate, and locking collar assembled in accordance with one embodiment of the invention;

FIG. 9 is a top right perspective view of a tamper proof lock in accordance with another embodiment of the invention; and

FIG. 10 is a top right perspective view of the tamper proof lock of FIG. 9 in accordance with another embodiment of the invention.

### DETAILED DESCRIPTION OF THE INVENTION

A tamper proof lock has a bolt with a retracted position and an extended position. A knob has a first position wherein a key operates the bolt and a second position wherein the key does not operate the bolt. A key plate is in opposition to the knob having a key slot.

In one embodiment, the knob has a locking collar attached to the shaft of the thumb knob. The locking collar has a locking orifice. A thumb knob plate has a locking pin that engages the locking orifice in the second position, wherein the thumb knob is pulled out from the thumb plate. This also stops a key inserted into the key plate from operating the bolt. As a result, bumping, picking, or drilling the lock will be ineffective to open a door with this invention in the second position as will unauthorized keys.

As will be clear to those skilled in the art there are numerous ways in which the bolt may be locked (or disengage) in place and therefore make the deadbolt lock tamper proof. All such mechanisms are incorporated as part of the invention

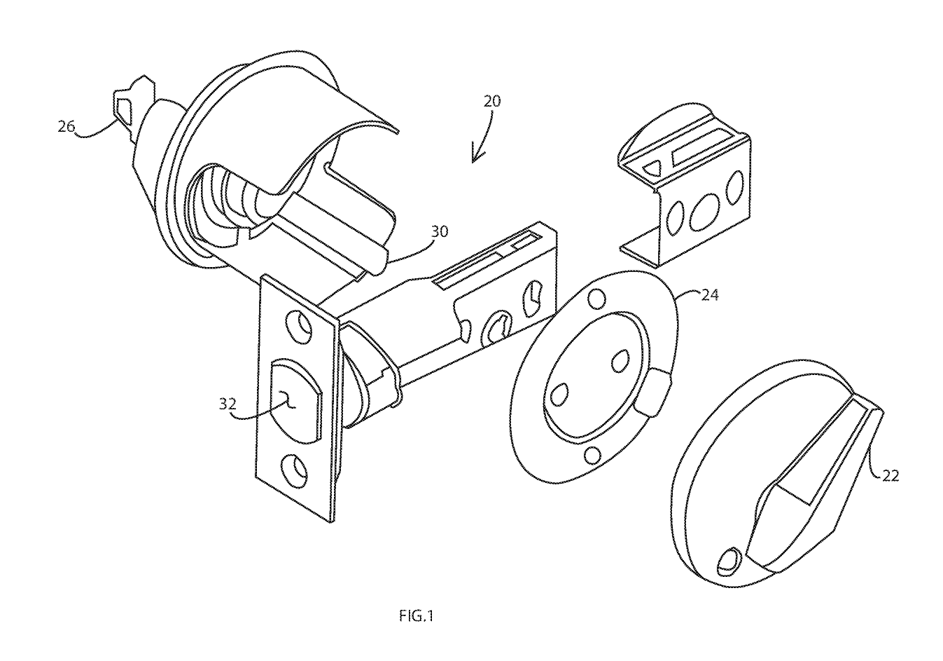

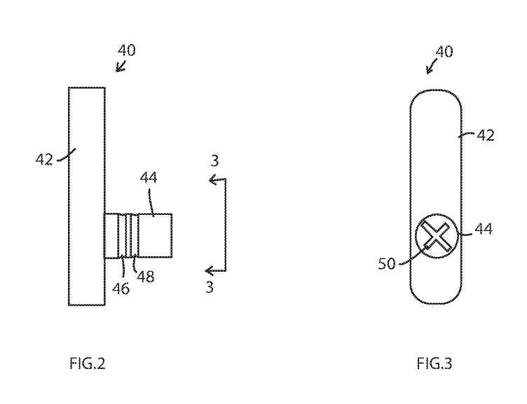

FIG. 1 is an exploded view of a deadbolt lock 20. This drawing shows the inner workings of a conventional deadbolt lock 20 and is shown to orient the reader to the invention. The deadbolt lock 20 has thumb knob 22 and thumb knob plate 24 opposite a key set 26 in a key set plate or barrel. A working shaft 30 extends through an opening in the bolt 32 and into an opening (shown in FIG. 3) on the shaft (shown in FIG. 2) of the thumb knob 22. As a result, if the thumb knob 22 is turned or the key is turned the bolt 32 goes between a retracted and extended position and vice versa.

FIG. 2 is a side view of a thumb knob 40 for a deadbolt lock in accordance with one embodiment of the invention. This thumb knob 40 is different than a standard thumb knob. The thumb knob 40 has a knob handle 42 and a shaft 44. The thumb knob 40 also has a pair of operating channels 46 and 48.

FIG. 3 is an end view of the thumb knob of FIG. 2 in accordance with one embodiment of the invention. The end of the thumb knob shaft 44 has an X shaped channel that mates with the end of the working shaft 30. In one embodiment, moving the thumb knob 56 between the first and second position disengages the X shaped channel from the working shaft 30.

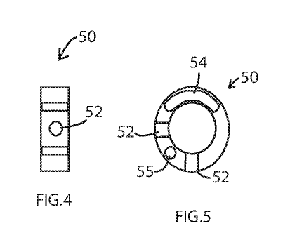

FIG. 4 is a side view of a locking collar 50 for a deadbolt lock in accordance with one embodiment of the invention. The locking collar 50 has a cylinder shape and is held to the thumb knob shaft 44 by a pair of setscrews 52 (only one of which is shown in this view).

FIG. 5 is a front view of the locking collar 50 of FIG. 4 in accordance with one embodiment of the invention. This figure shows the guide channel 54 and the locking orifice 55.

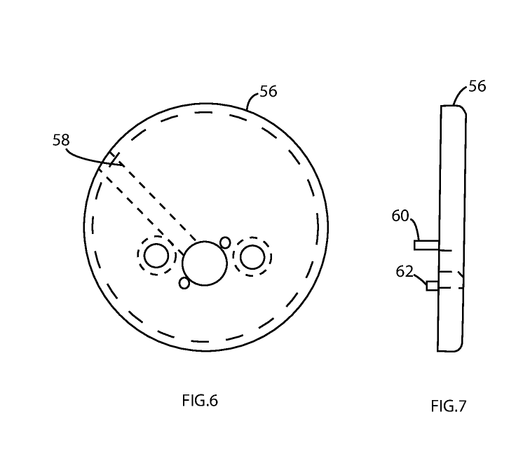

FIG. 6 is a back view of a thumb knob plate 56 for a deadbolt lock in accordance with one embodiment of the invention. This thumb knob plate 56 is different than a conventional thumb knob plate. It has a spring loaded ball plunger, which engages the operating channel 46 or 48 on the thumb knob shaft 44 depending on the position of the thumb knob.

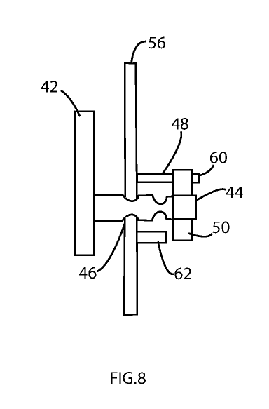

FIG. 7 is a side view of the thumb knob plate 56 of FIG. 6 in accordance with one embodiment of the invention. This figure shows that the thumb knob plate 56 has a guide pin 60 which engages the guide channel 54 of the locking collar 50 and a shorter locking pin 62. The locking pin 62 mates with the locking orifice when the thumb knob is pulled out and the bolt is fully extended. This prevents the thumb knob or the key from being able to actuate the bolt.

FIG. 8 is a side view of the thumb knob, thumb plate, and locking collar assembled in accordance with one embodiment of the invention. This figure shows the thumb knob 42 is the first or operating position. In this case the thumb knob shaft 44 turns inside the thumb plate 56 on the first operating channel 46. The guide pin 60 extends into (or through) the guide channel of the locking collar 50. The locking pin 62 is offset from the locking collar 50 and does not engage the locking orifice when the thumb knob is in the operating position. When the bolt is in the extended position, the locking pin 62 and the locking orifice 55 are aligned and the thumb knob handle 42 can be pulled out so the thumb knob shaft 44 engages the ball plunger on thumb plate 56 in the second operating channel 48 and the locking pin 62 engages the locking orifice 55 preventing the bolt from being operated.

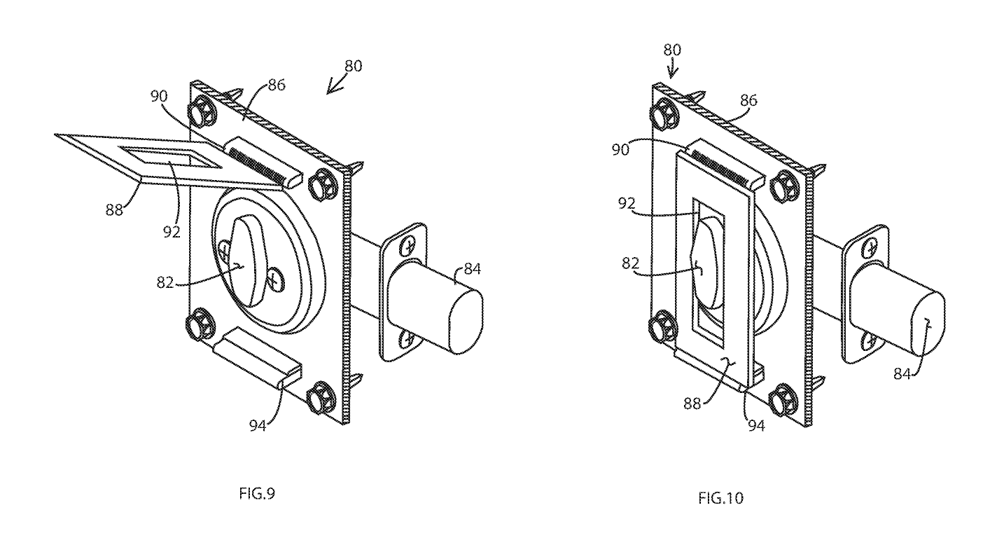

FIG. 9 is a top right perspective view of a tamper proof lock 80 in accordance with another embodiment of the invention. The deadbolt lock 80 has a thumb knob 82 that actuates the bolt 84. A thumb knob plate 86 has a plate 88 attached by a hinge 90, which may be spring loaded to hold the plate 88 up. The plate 88 has a slot 92 that mates with the thumb knob 82. This figure shows the plate in the operating position.

FIG. 10 is a top right perspective view of a tamper proof lock 80 in accordance with another embodiment of the invention. This figure shows the plate 88 in the closed position. The plate 88 is held is place with a friction fit against the ledge 94. In another embodiment, it may be held in place by a latch or other mechanism.

As will be clear to those skilled in the art there are numerous ways in which the bolt may be locked in place and therefore make the deadbolt lock tamper proof. All such mechanisms are incorporated as part of the invention.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A tamper proof lock, comprising:
a bolt having a retracted position and an extended position;
a knob having a first position wherein a key operates the bolt and a second position wherein the key does not operate the bolt; and
a key plate in opposition to the knob having a key slot.

2. The lock of claim 1, wherein the key does operate the bolt when the knob is in the first position.

3. The lock of claim 1, wherein the knob does not operate the bolt when the knob is in the second position.

4. The lock of claim 1, further including a locking collar attached to a shaft of the knob.

5. The lock of claim 4, further including a locking pin extending from a knob plate

6. The lock of claim 5, wherein the locking collar has a locking orifice that engages a locking pin, when the knob is in the second position.

7. A tamper proof lock, comprising:
a bolt having a retracted position and an extended position; and
a first actuation mechanism having a first position and second position; and
a second actuation mechanism, wherein the second actuation mechanism does not operate the bolt when the first actuation mechanism is in the first position.

8. The lock of claim 7, wherein the second actuation mechanism, operates the bolt when the first actuation mechanism is in the first position.

9. The lock of claim 7, wherein the bolt is locked in place when the first actuation mechanism is in the second position.

10. The lock of claim 9, further including a locking collar attached to a shaft of the first actuation mechanism, wherein the locking collar has a locking orifice.

11. The lock of claim 10, further including a locking pin on a plate associated with the first actuation mechanism.

12. The lock of claim 11, wherein the locking pin engages the locking orifice when the first mechanism is in the second position.

13. The lock of claim 11, wherein the locking pin does not engage the locking orifice when the first mechanism is in the first position.

14. A tamper proof lock, comprising:
a bolt having a retracted position and an extended position; and
a mechanism having a first position in which the bolt can be moved from an extended position to a retracted position and a second position in which the bolt cannot be moved from the extended position to the retracted position.

15. The lock of claim 14, wherein the mechanism is a plate having a first end that is hinged to a thumb knob plate and has a slot that fits over a thumb knob in the second position.

16. The lock of claim 15, wherein the hinged connection is spring loaded.

17. The lock of claim 14, wherein the mechanism includes a thumb knob with a thumb knob plate having a locking pin.

18. The lock of claim 17, further including a locking collar connected to a shaft of the thumb knob and having a locking orifice.

19. The lock of claim 18, wherein the locking pin engages the locking orifice when the mechanism is in the second position.
